(19) United States
(12) Patent Application Publication
(10) Pub. No.: US 2015/0106912 A1
(43) Pub. Date: Apr. 16, 2015

(54) REMOTE MACHINE MONITORING SYSTEMS AND SERVICES

(71) Applicant: Milacron LLC, Cincinnati, OH (US)

(72) Inventors: Carl J. BRANDON, Blue Ash, OH (US); Lawrence R. KELLER, Loveland, OH (US); Mark R. VANZANT, Cincinnati, OH (US)

(21) Appl. No.: 14/516,121

(22) Filed: Oct. 16, 2014

Related U.S. Application Data
(60) Provisional application No. 61/891,524, filed on Oct. 16, 2013.

(51) Int. Cl. B29C 45/76; H04L 29/06; H04Q 9/00

(52) U.S. Cl. CPC B29C 45/76; H04Q 9/00; H04L 63/02; B29C 2945/76993
USPC 726/13; 340/870.07

(57) ABSTRACT

The present disclosure describes illustrative, non-limiting embodiments of systems, apparatuses, and methods that can be used to facilitate the remote monitoring and support for manufacturing machines. In one particular embodiment, the techniques may be realized as a method for remote monitoring comprising the steps of storing a measurement taken of an injection molding machine to a machine controller associated with that machine; receiving operation data for the injection molding machine including the stored measurement from the machine controller; and remotely displaying the received data including the stored measurement to a first user at a location distant from the machine.

### CROSS-REFERENCE TO RELATED APPLICATION

This application claims priority to U.S. Provisional Application No. 61/891,524, filed Oct. 16, 2013, which is hereby incorporated by reference in its entirety.

### FIELD OF THE DISCLOSURE

The present disclosure relates generally to an apparatus, system, and method for remotely monitoring manufacturing equipment.

### BACKGROUND OF THE DISCLOSURE

Efficiency, cost, and quality are all important aspects of operating industrial machinery. The profitability of a machine may very well be dependent on smooth operation and swift, effective repair to maximize uptime. For complex machines including many moving parts in synchronized operation, it is critical that the health of each component of the machine is maintained.

Traditionally, industrial machines require available experts on-site to monitor machine health and performance, and to make any necessary adjustments or repairs. The staffing requirements can create significant expense which may significantly impact the profitability of some manufacturing processes.

Automated and remote monitoring techniques, which may reduce the costs of on-site staff while still ensuring effective machine operation, are desired.

### SUMMARY

The present disclosure describes illustrative, non-limiting embodiments of systems, apparatuses, and methods that can be used to facilitate the remote monitoring and support for manufacturing machines. In one particular embodiment, the techniques may be realized as a method for remote monitoring comprising the steps of storing a measurement taken of an injection molding machine to a machine controller associated with that machine; receiving operation data for the injection molding machine including the stored measurement from the machine controller; and remotely displaying the received data including the stored measurement to a first user at a location distant from the machine.

As a further aspect of the particular embodiment, the method may further comprise the steps of remotely determining a status of the machine based on the received data; determining one or more remedial actions in response to the status of the machine; and communicating the one or more remedial actions to a second user located with the machine.

As a further aspect of the particular embodiment, the method may further comprise the steps of remotely determining a status of providing data representing the operation of the injection molding machine to an expert remote from the machine; receiving a diagnosis of the machine from the remote expert; and providing the remote expert diagnosis to a second user located with the machine.

As a further aspect of the particular embodiment, the method may further comprise the steps of automatically generating overall equipment effectiveness analysis based on the received operational data; and providing the overall equipment effectiveness analysis to the remote user.

As a further aspect of the particular embodiment, the method may further comprise the step of generating one or more predictions representing the future operation of the machine based on applying a statistical analysis of operation data from a plurality injection molding machines to the operation data received from the injection molding machine.

As a further aspect of the particular embodiment, the method may further comprise the steps of deploying a sensor on the injection molding machine and receiving data from the sensor; wherein the one or more predictions are further generated based on the sensor data.

As a further aspect of the particular embodiment, the controller can be configured to accumulate and store operational data for the injection molding machine for later remote retrieval.

As a further aspect of the particular embodiment, the method may further comprise the step of deploying a firewall between the controller and the remote data center configured to prohibit control of the injection machine through the network.

As a further aspect of the particular embodiment, the method may comprise the additional steps of remotely determining a status of the machine based on the received data; determining one or more remedial actions in response to the status of the machine; and communicating the one or more remedial actions to a second user located with the machine.

In accordance with another exemplary embodiment, the techniques may be realized as an article of manufacture including at least one processor readable storage medium and instructions stored on the at least one medium. The instructions may be configured to be readable from the at least one medium by at least one processor and thereby cause the at least one processor to operate so as to carry out any and all of the steps in the above-described method.

In another particular embodiment, the techniques may be realized as a system comprising an injection molding machine including a controller communicatively coupled to a network and a remote data center comprising one or more processors communicatively coupled to the network. The one or more processors can be configured to receive data from the controller representing the operation of the injection molding machine over time and, based on the received data, automatically generate one or more predictions representing the future operation of the machine.

As a further aspect of the particular embodiment, the one or more processors may be further configured to provide data representing the operation of the injection molding machine to an expert remote from the machine; receive a diagnosis of the machine from the remote expert; and provide the remote expert diagnosis to a user of the remote data center.

As a further aspect of the particular embodiment, the one or more processors may be further configured to provide the received operation data to a user of the remote data center located remotely from the injection molding machine.

As a further aspect of the particular embodiment, the one or more processors may be further configured to automatically generate overall equipment effectiveness analysis based on the received operational data; and provide the overall equipment effectiveness analysis to the remote user.

As a further aspect of the particular embodiment, the one or more predictions are generated based on applying a statistical analysis of operation data from a plurality injection molding machines to the operation data received from the injection molding machine.

As a further aspect of the particular embodiment, the system can further include a sensor deployed on the injection molding machine configured to provide data to the remote data center. The one or more predictions may be further generated based on the sensor data.

As a further aspect of the particular embodiment, the controller can be configured to accumulate and store operational data for the injection molding machine for later retrieval by the remote data center.

As a further aspect of the particular embodiment, the system can include a firewall deployed between the controller and the remote data center configured to prohibit control of the injection machine through the network.

As a further aspect of the particular embodiment, the system can include a plurality of the said injection molding machines each having a controller, the one or more processors configured to receive operational data over time for each machine from its respective controller.

This and other capabilities of the disclosed subject matter will be more fully understood after a review of the following figures and detailed description. It is to be understood that the phraseology and terminology employed herein are for the purpose of description and should not be regarded as limiting.

### BRIEF DESCRIPTION OF THE FIGURES

The included figures each illustrate a different part of the techniques described herein. Their contents are outlined briefly here and then more fully described when relevant to the disclosure below.

FIG. 1 is a block diagram illustrating an exemplary injection molding machine according to an illustrative embodiment.

FIG. 2 is a diagram of an illustrative embodiment of remote data collection architecture.

FIG. 3 is an exemplary screen shot of an overview screen according to an illustrative embodiment.

FIG. 4 is an exemplary screen shot of a remote monitoring portal screen for selecting data points for display according to an illustrative embodiment.

FIG. 5 is an exemplary screen shot of a customizable process monitoring report according to an illustrative embodiment.

FIG. 6 is an exemplary screen shot of a remote monitoring portal machine list according to an illustrative embodiment.

FIG. 7 is a flowchart illustrating an exemplary method for remote monitoring and analysis according to an illustrative embodiment.

These and other capabilities of the disclosed subject matter will be more fully understood after a review of the figures and detailed description. It is to be understood that the phraseology and terminology employed herein are for the purpose of description and should not be regarded as limiting.

### DESCRIPTION OF THE DISCLOSURE

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. These descriptions should be understood to represent exemplary features of certain embodiments, and not all implementations will include all or any particular described feature. Different combinations of these features will afford different benefits as understood in the art.

### Injection Molding Machine

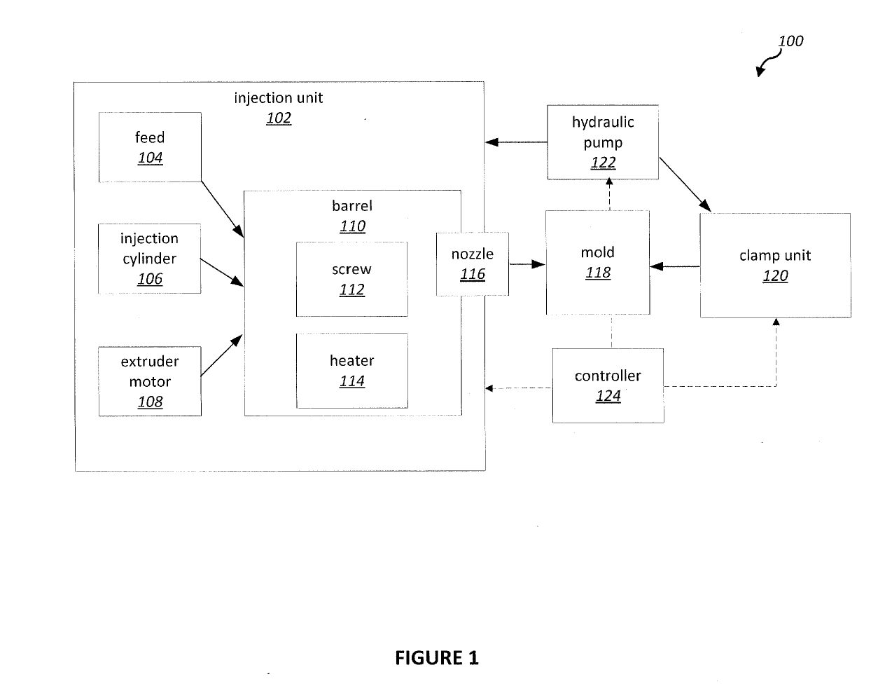

FIG. 1 illustrates an injection molding machine 100 for carrying out an injection molding manufacturing process. The machine 100 includes an injection unit 102, within which material is fed from a feed 104 into a barrel 110. As the material is melted by a heater 114, an extruder motor 108 operates a screw 112 to push the material forward into the part of the barrel nearest a nozzle 116. The accumulated melt is then injected into a mold 118 by the action of an injection cylinder 106. A clamp unit 102 may apply pressure to the mold 118 to keep it in place during the injection process. Hydraulic pumps 112 may provide the driving pressure for either the clamp unit 120 and/or the injection unit 102; in other implementations, electrical motors may provide the pressure.

Each of the components of the machine 100 may be in communication with a machine controller 124, which may send commands for the automated operation of any of the components of the injection molding machine 100 and may receive any data generated by any of the components of the machine 100. The controller 116 may further be in communication with aspects of a remote monitoring platform as further described herein.

The block diagram of FIG. 1 illustrates some commonly-included components of an injection molding machine for illustrative purposes, but is not intended to be comprehensive. It will be understood some injection molding machines may have different components than the exemplary block diagram. A variety of accessories such as mold gates, vacuum valves, ejectors, air ejectors, poke bars, or cores may be included. Although the machine 100 is illustrated with a single injection unit 102, it will be understood that some injection molding devices use more than one injection unit with a single mold. The components of an injection molding machine should therefore not be limited to that described or mentioned explicitly herein.

### Production and Performance Monitoring

In some implementations, a remote monitoring system provides for the capability to collect, over the internet, process, production, power, and other machine parameters on an injection molding machine or extruder, and store it in the cloud. Process data such as actual melt temperatures, actual injection pressures, actual injection speeds, actual extruder speeds, actual cool times, and their respective set points on the machine can be collected for quality analysis of the parts produced. Production data such as machine mode of operation, cycle times, parts counts, and machine system actual speeds and setpoints can be collected for machine uptime, availability, and productivity analysis. A combination of process and production data, giving quality and speed data respectively, can be used for overall equipment effectiveness (OEE) analysis. Power usage may also be collected over the internet using the remote monitoring system. It can be plotted, and basic calculations can be done to show energy usage per part, per cycle, and over various time periods.

In some implementations, software associated with a remote monitoring system may be configured to plot production, process, and power data for a machine. The system may be able to automatically run basic analysis on this data to show downtime and OEE calculations. The system may provide the data and tools necessary for a manager to calculate production costs or machine utilization for each piece of manufacturing equipment.

In some implementations, data may be received from the machine controller associated with one or more injection molding machines. The machine controller may store data from sensors on the injection molding machine including actual temperatures, pressures, speeds, positions, their corresponding set points, as well as production data such as cycles, parts produced, and various other production related parameters. The machine controller may be configured to store this data in a buffer for one or more cycles and to make it available to the system. As an example, the machine controller may make the data available over a serial or Ethernet protocol such as PVI, OPC, or GCL communications. Some implementations of the remote monitoring system may include a data center running a data collection agent, set up to collect the available parameters using the correct protocol corresponding to that specific machine.

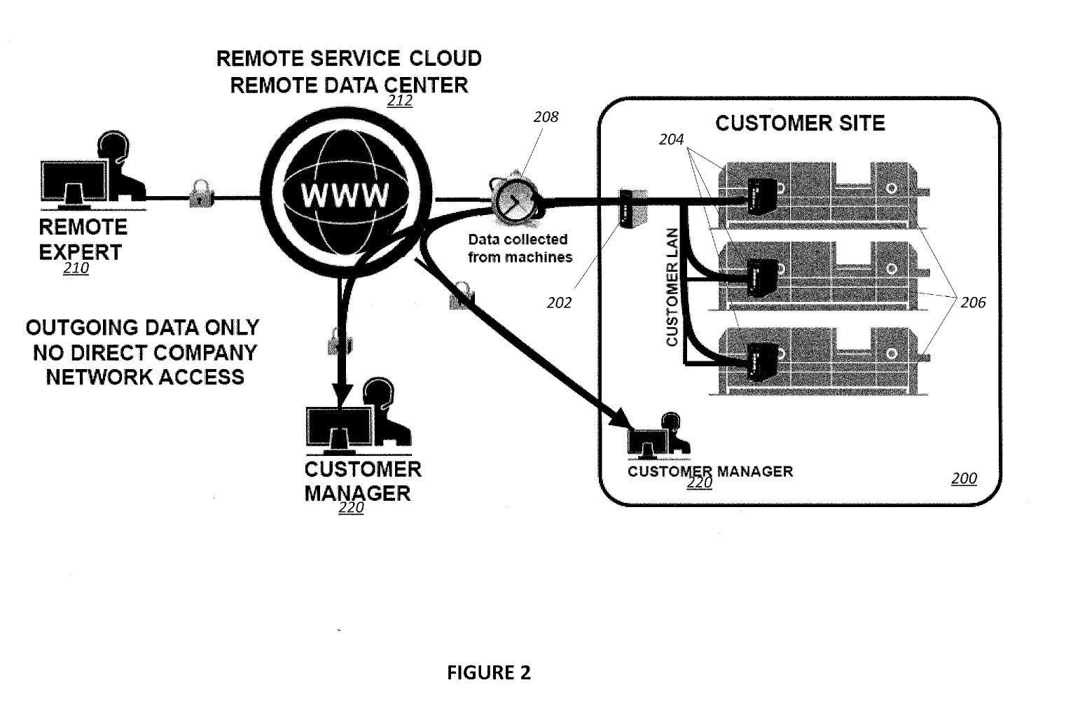

In some implementations of the system for monitoring an injection molding machine, a link is established between the remote monitoring data center and the injection molding machine through a machine network 200, as illustrated in FIG. 2. Each machine network 200 may include a router 202 which establishes a firewall between the outside internet and the machine network. Each machine network 200 may further include one or more boxes 204 which establish a firewall between the injection molding machine 206 and the machine network 200. The combination of the different networking devices 202, 204 allows the data collection agent running on the data server to establish a secure internet connection to each injection molding machine. The correct protocol to access that machine's parameters is utilized by the data collection agent running in the data server 208 to collect the values of the production, process, and machine parameters. The system may further include a web interface, hereafter referred to as the platform, which presents data to authorized users by populating graphs and charts with the data it has collected from the data collection agent. Further devices may also be attached to communicate with the machine and perform additional communication and control purposes, such as facilitating a VPN or other connection for remote analysis and control.

The system may further be configured to incorporate existing fault states and alarms from the machine controller into the remote monitoring process so as to communicate any such information to a remote user.

In some implementations, where the machine controller software can be modified, the system can be set up so that data is buffered on the controller in the form of a file and made available to the machine's respective box 204 via FTP, or, rather than buffered on the controller, written directly to the machine's respective box via a network share or other file transfer method. Once the files, and therefore the data, are on the box 204, they can be compressed, for example being put in a zip archive, before being sent to the data server. They could also be compressed on the controller itself, but the method of transferring them to the box first relieves the machine controller of this processor overhead, which may be valuable where processor overhead on the machine controller itself is limited for example in legacy applications with dated processors.

If the parameters being sent from the controller and received by the data server are pre-defined at both ends, parameter identifiers need not be used in the file transfer method. This gives the file transfer method two distinct advantages in bandwidth usage over request-response communication protocols such as PVI, OPC, or GCL, first because the data is compressed before being sent, and second because it lacks the parameter identifiers being included in request response communication protocols, reducing message size.

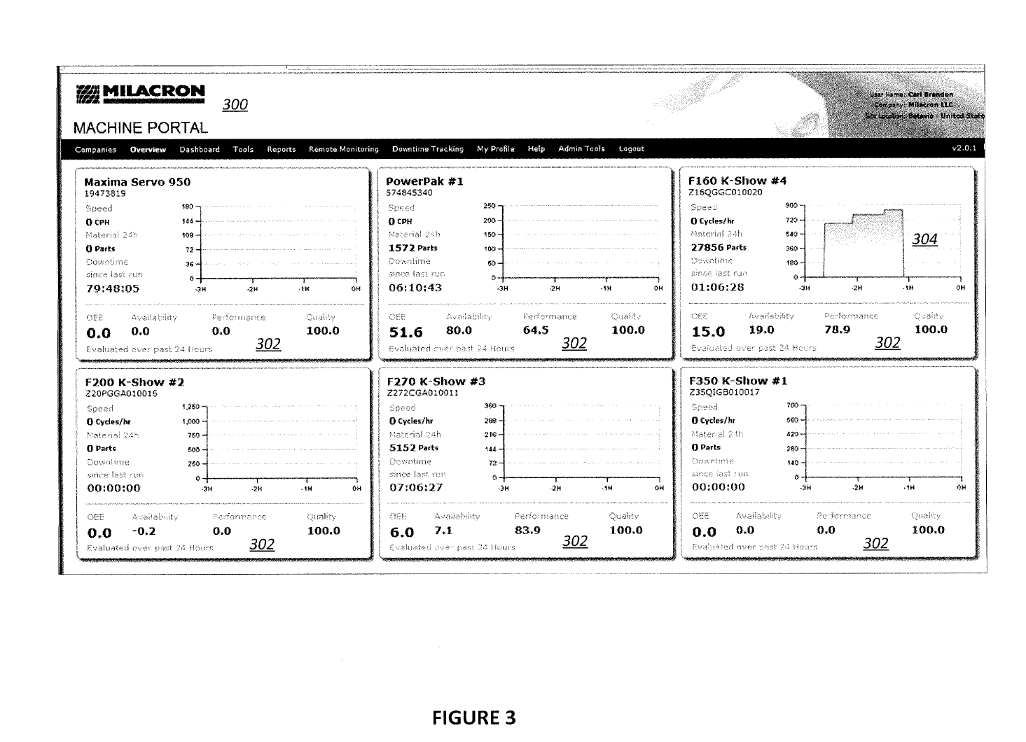

FIG. 3 shows an example of an overview screen 300 for a remote monitoring platform, wherein the system may automatically calculate an OEE score based on data collected from each machine. Each machine summary 302 shows an OEE score calculated from Availability, Performance, and Quality scores, and a chart 304 that displays data representing recent machine performance charted over time. The machine summary 302 may display additional data, such as the current running speed of the machine in cycles, the parts produced by the machine in the past 24 hours, and the downtime since the last run. Selecting one of the machine summaries 302 may present the user with more data for the selected machine.

In some implementations, both the calculations and the underlying data may be available remotely to a manager or other system user as needed. The remote monitoring platform may be able to provide to a user a detailed downtime report and analysis for machines based on the monitoring system as described herein, which may also be available remotely. Reports and analysis may include graph and chart summaries of total downtime according to different categories, charts of the downtime per day in each category over any period of time requested, and a detailed log including the time and date of each downtime event as well as the length of downtime. The user may be able to specify the length and format of each report.

In some implementations, the system may further monitor various other parameters such as oil temperature, motor temperature, motor speeds, lube counters, motor torque feedback, and vibration data from motors, pumps, screws and perhaps other systems on the injection molding machine. Some of these data may not be directly related to production and process data, but may nonetheless provide information for maintaining the machines.

In some implementations, certain monitored parameters may include acceptable ranges which may be default or may be configured by an end user. The system may send alerts to an end user when a monitored parameter falls outside of the configured range. The alerts may include any method by which the system can contact the user, such as an SMS or instant message, an email, an alert in an application, etc.

By combining the process set points, process actuals, various other machine parameters, and doing some statistical correlation, the remote system may provide all of the necessary data for a user to assess the health of certain systems on the injection molding machine, including the extruder, injection unit, clamp, ejector, cores, motors, pumps, valves, and hydraulic cylinders. In some implementations, certain diagnostic functions and alerts may be configured automatically from statistical analysis of the data performed by software associated with the monitoring system.

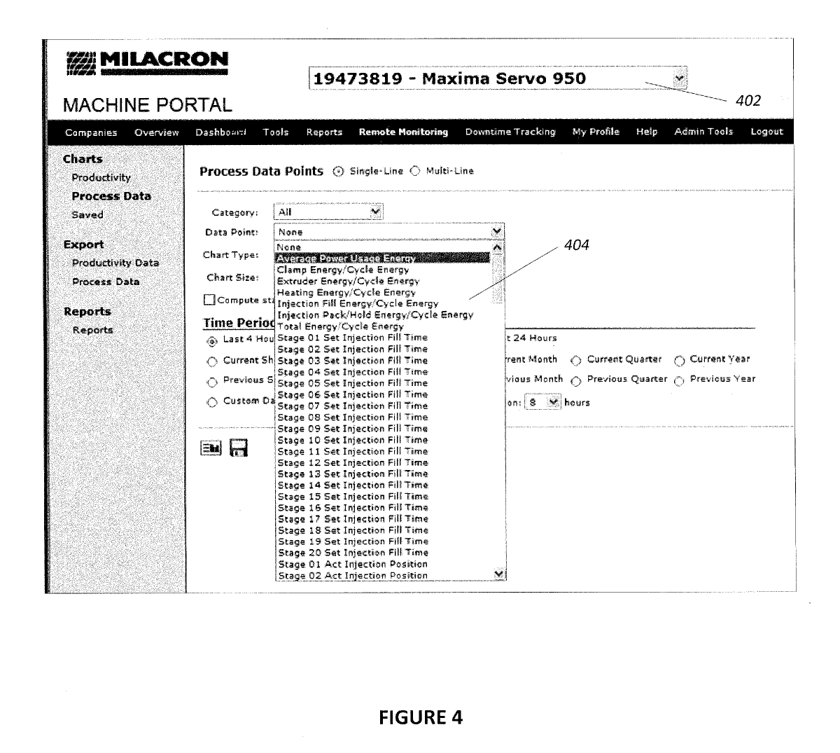

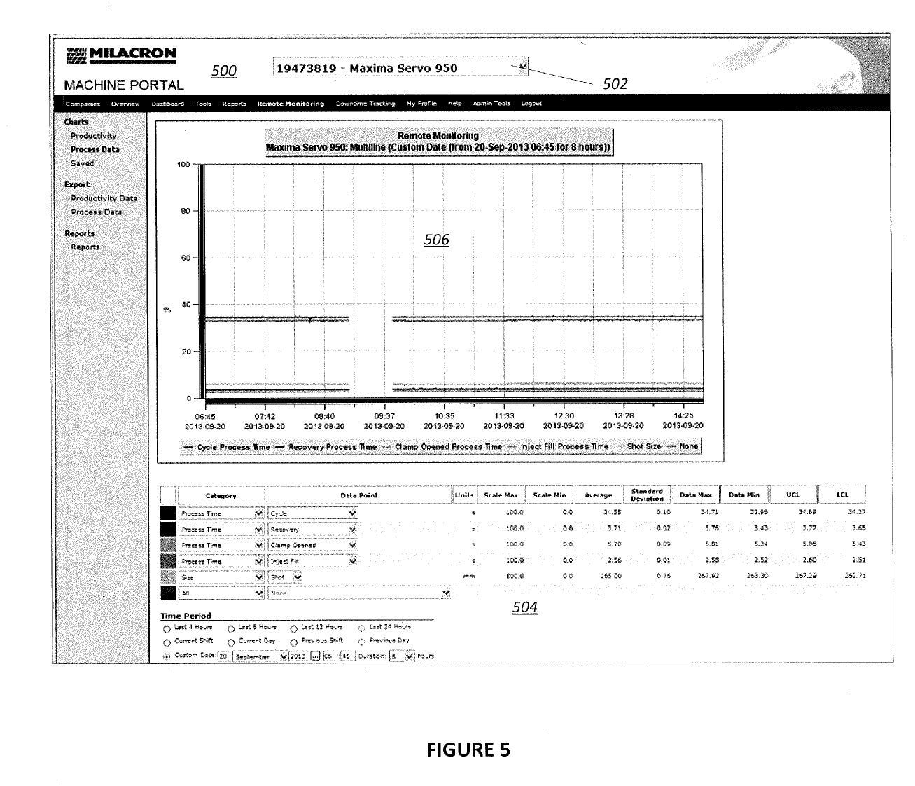

A portal for reviewing data collected by a remote monitoring system is shown in FIGS. 4 and 5. In FIG. 4, a user may select which collected data points to review for a particular screen and over what period. The portal interface 400 includes a machine list 402 from which a user can select which machine to review, and a data point list 404 from which the user can select any of the types of data collected for that particular machine, which can then be displayed on a chart. The portal interface 400 may allow the user to customize other parameters of the data to be displayed, including the chart type and size and the period of time that the chart should include.

FIG. 5 illustrates one example of data that may be presented to a user through a remote monitoring platform. The customizable display 500 allows the user to access relevant data, which the user may then use to determine machine profitability or identify possible concerns in machine performance. The user can select a machine from the machine list 502, and can view any available data on any scale over any time period by making selections on the data console 504. The resulting chart 506 may provide data customized according to the user's preferred metrics for analysis. In some implementations, the remote monitoring portal may also allow for the export of data into other formats for analysis by other data processing and diagnostic software.

### Remote Monitoring Services

In some implementations, the system data described above may be made available to operatives of a monitoring and trouble-shooting service provided for the manufacturing machines. In addition to automated performance analysis and customized reporting, the system may allow a remote expert to have direct access to each machine. The remote expert may be able to use any and all of the data collected through the remote monitoring system, as described above, in order to diagnose current problems as well as prescribe necessary maintenance to curtail future problems.

In some implementations, a remote agent may have access to the control details of the machine. A custom key may be required to access particular machine details, and the system may keep records of what details are accessed and when. In some implementations, an expert or team of experts may be able to reliably diagnose and fix problems in relatively short periods of time using the remote monitoring system.

Returning to FIG. 2, the data server 208 may upload collected data to a remote data center and remote service cloud 212. A remote expert 210 may access the uploaded data as shown. In some implementations, the data flow may be generally one-way to the monitoring and trouble-shooting service: the expert 210 can access data indicating machine performance, but cannot modify any data or otherwise control the machines 206. The system may be configured to give a customer manager 220 or other internal user of the system different access than the remote service.

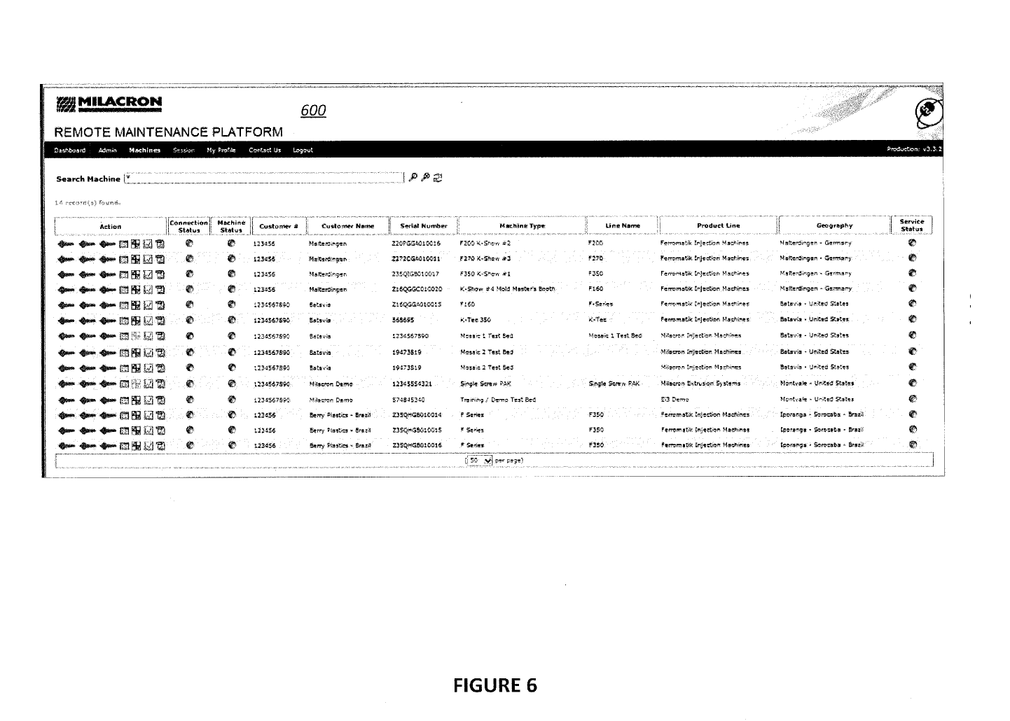

In some implementations, the remote monitoring system may collect data from multiple customers' systems so as to allow a remote expert for the monitoring and trouble-shooting service to monitor machines from multiple clients simultaneously. FIG. 6 illustrates an exemplary screen of a machine list 600 for a portal to a remote data center including the data from multiple clients. The machine list 600 may include a list of any of the machines assigned for monitoring and trouble-shooting to a remote expert, and may include a summary status of each listed machine. As shown, whether each machine registers an extra connection and is currently running may be shown on the machine list 600, along with information regarding the type and location of the machine and the identity of its owner.

A remote expert may be able to select any one of the machines listed on the machine list 600 in order to access further data about the selected machine. In some implementations, a data repository such as a remote data center may be maintained by the remote monitoring service and may limit access to users associated with each particular client such that only machines associated with that client are visible to those users.

### Automated Diagnostics and Analysis

In some implementations, the machine controller may put the machine in a known state in order to run automated diagnostics. The system may measure various machine parameters while in the known state, including high frequency vibration data, and store them to a file. As described above, the system may then utilize a secure connection to the machine controller to retrieve that file and store it in the cloud. The system may then apply quantitative, correlative, and comparative analysis using data from the file to assess the health of various systems on the injection molding machine.

In some implementations, automated analysis may be done on vibration data. The system may include vibration sensors such as high frequency vibration analog inputs which may be connected to a separate processor or to a controller associated with other aspects of the remote monitoring system. The vibration sensors attached to the injection molding machine may be used to monitor the health of specific components of the machine. For example, motors, pumps, screws, and other sub-systems may be analyzed automatically by means of vibration data. In some implementations, vibration data may be sent to and analyzed by a separate system, and the resulting analysis provided as part of a remote monitoring platform as described herein.

By continually monitoring the injection molding machine, the system produces a better real-time view of its health, whether using vibration data, temperature data, oil quality testing, thermal imaging, flow meters, or pressure transducers. In some implementations, the system can use statistical correlations between existing faults, instrumentation, and process data to predict when parts are likely to fail.

As an example, if the clamp speed set point stays the same while the velocity feedback from the position transducer decreases, while everything else runs fine, the system might be able to deduce that flow to the clamp cylinders is being impeded. By tying the data into a machine integrated diagnostic tree, integrating data from the instrumented machine, and querying the user for additional information, the system could provide automated trouble-shooting and repair recommendations to the client.

The data stored in the remote data center for any large number of machines over any significant length of time may be aggregated and combined with enterprise level parts quoting and sales databases to provide automated MTBF analysis of individual parts on the machine through the use of data mining algorithms on data from existing sensors on the machine. Through such data mining techniques including but not limited to regression analysis or the use of neural networks, parameters already being monitored may allow accurate prediction of the useful lifecycle of parts or systems on the machine that are not being actively monitored. This presents an opportunity for cost savings on hardware as information is gained without the use of additional sensors on the machine.

As an example, total distance traveled by the clamp weighted by its speed might be indicative of when the skids will need to be replaced. The system may be able to calculate, for every machine of the same type, the total distance traveled by the clamp at any given time in the history of that machine by combining the clamp open and close setpoints with the number of cycles run, and weighting it by the clamp open and close speed setpoints. When combined with enterprise data on when customers ordered replacement skids, an equation can be formed using regression analysis, neural networks, or another data mining algorithm, which can relate skid failure to the existing collected parameters, including but not limited to those previously mentioned.

For example, a preprogrammed opening process for the clamp may include three stages, each of which has a distance d₁, d₂, and d₃ over which the clamp moves and a speed v₁, v₂, and v₃ during which it moves. Each velocity range may be associated with a wear factor which may be determined by an function w(v) in terms of the velocity. The calculated wear for each run of the opening process may therefore be:

wear=d₁*w(v₁)+d₂*w(v₂)+d₃*w(v₃)

More generally, each movement of the clamp over a distance dₙ at a speed vₙ may be given a wear factor of dₙ*w(vₙ), and the total wear given as the sum over all i (stages) and j (cycles) of:

Total wear=(Σⱼ(Σ(dᵢ*w(vᵢ))+twf)+twf(t)

where cwf is a cycle wear function (probably a constant), and twf is a time wear function, both of which may affect skid wear independent of distance traveled (rust, vibration from clamping system, start-stop wear, etc.) and where the wear function for clamp velocity, cycles, or time could be any number of mathematical relationships including but not limited to logarithmic, exponential, and polynomial functions (for example. w(v)=a*v+b where a and b are constants).

The regression analysis or neural network is then used to determine the constants in these weighting functions which minimize the difference between an arbitrary failure value and the total wear values at which the enterprise system indicates there was a failure (known failures).

These known failures provide the constant values for a predictive equation that can then be used for all similar machine types to predict when skids on those machines will need to be replaced, without any additional instrumentation monitoring skid wear. This predictive equation on skid failure could then further be useful for skid inventory planning of the machine manufacturer or scheduling routine. As the machines produce actual failure data relative to different wear values, the predictive equation can provide a more accurate model, eventually giving us a failure distribution that would be able to give percentage failure rates at a given wear value.

A similar technique can be used to predict failure for almost every part on the machine at least partially dependent on any system whose health is being actively monitored or is related to total machine use and whose wear can therefore be aggregated using existing stored machine and enterprise data. For example, humidity and temperature data from the factory HVAC system could be integrated to determine its influence on system wear.

In some implementations, a complete system for diagnosing the root cause of a machine failure may include a diagnostic tree. The system may integrate data from a number of sources including (but not limited to) instrumentation on the machine, a statistical database of correlated historical process information and instrumentation data residing on a remote data server, and user-input data collected at the machine from queries that allow the machine logic to traverse the branches of the diagnostic tree at points where the existing data alone is not enough to narrow the possible cause. The diagnostic tree may be generated over time from field service data collected by agents in the field in addition to remotely monitored machines.

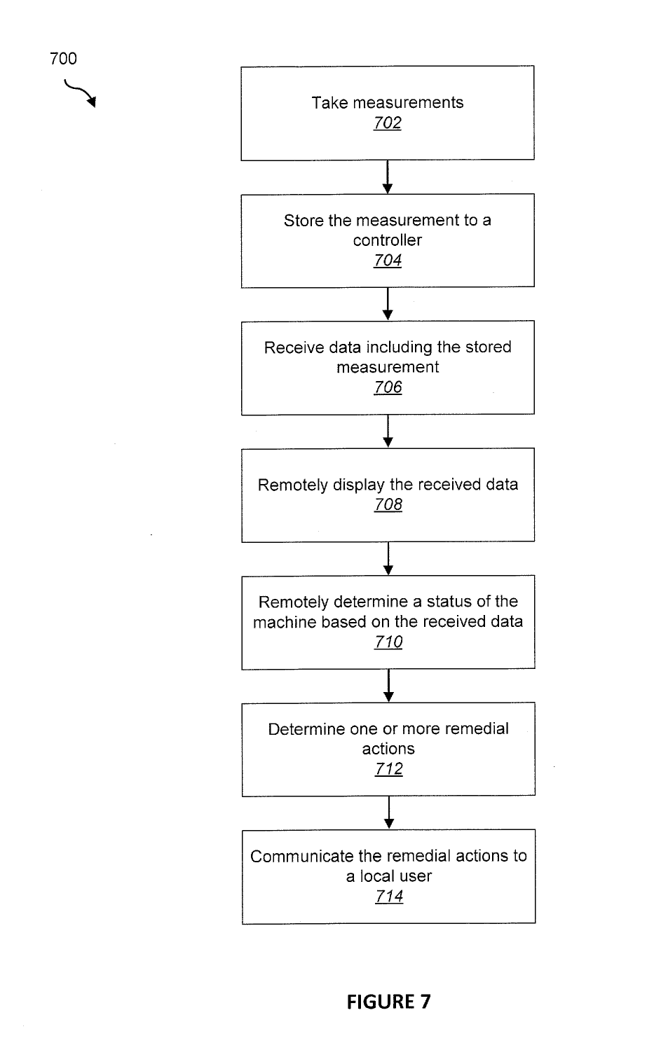

FIG. 7 is a flowchart illustrating an exemplary method 700 for remote monitoring and analysis in accordance with the present disclosure. The analysis relies on the taking of one or more measurements in conjunction with the operation of an injection molding machine as described herein (702).

The measurement may be stored to a machine controller, which as described above may control the operation of different components of the machine (704). The controller may be configured to transmit data including stored measurements regularly, either as the data is acquired or periodically after data has accrued, as described herein.

A remote monitoring system can receive the data, including the stored measurement, at a location remote from the monitored machine (706). The data may be processed and stored with other similar data to form a data set for the particular machine, which may be viewable in various respects by a user accessing the remote system (708). In addition to making the received data accessible to remote users, the system may also derive a machine status from the data (710). In some implementations, this step may be performed by means of an automated analysis of the data, as described above. A remote user such as a remote expert, as described above, may also participate in the determination of a status for the injection molded machine.

Some status may require local action to maintain the machine, such as clearing a clog, replacing a worn or broken part, or performing other necessary maintenance. In some implementations, the system may determine one or more remedial actions (712) and may communicate that behavior to a local user (714). The communication may come as an SMS, email, or other alert as appropriate (such as an alert message inserted in a portal for an active user accessing the platform from the same location as the machine). The local user may then take the remedial action necessary, which may be monitored and subsequently reported-on by the remote monitoring system.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in a non-transitory information carrier (e.g., in a machine readable storage device) for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the preceding description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A system comprising:
an injection molding machine including a controller communicatively coupled to a network; and
a remote data center comprising one or more processors communicatively coupled to the network; wherein the one or more processors are configured to:
receive data from the controller representing the operation of the injection molding machine over time; and
based on the received data, automatically generate one or more predictions representing the future operation of the machine.

2. The system of claim 1, wherein the one or more processors are further configured to:
provide data representing the operation of the injection molding machine to an expert remote from the machine;
receive a diagnosis of the machine from the remote expert; and
provide the remote expert diagnosis to a user of the remote data center.

3. The system of claim 1, wherein the one or more processors are further configured to provide the received operation data to a user of the remote data center located remotely from the injection molding machine.

4. The system of claim 3, wherein the one or more processors are further configured to:
automatically generate overall equipment effectiveness analysis based on the received operational data; and
provide the overall equipment effectiveness analysis to the remote user.

5. The system of claim 1, wherein the one or more predictions are generated based on a applying a statistical analysis of operation data from a plurality injection molding machines to the operation data received from the injection molding machine.

6. The system of claim 1, further comprising a sensor deployed on the injection molding machine configured to provide data to the remote data center;
wherein the one or more predictions are further generated based on the sensor data.

7. The system of claim 1, wherein the controller is configured to accumulate and store operational data for the injection molding machine for later retrieval by the remote data center.

8. The system of claim 1, further comprising a firewall deployed between the controller and the remote data center configured to prohibit control of the injection machine through the network.

9. The system of claim 1, wherein the system comprises a plurality of the said injection molding machines each having a controller, the one or more processors configured to receive operational data over time for each machine from its respective controller.

10. A computer-implemented method for remote monitoring, comprising:
storing a measurement taken of an injection molding machine to a machine controller associated with that machine;
receiving operation data for the injection molding machine including the stored measurement from the machine controller; and
remotely displaying the received data including the stored measurement to a first user at a location distant from the machine.

11. The method of claim 10, further comprising:
remotely determining a status of the machine based on the received data;
determining one or more remedial actions in response to the status of the machine; and
communicating the one or more remedial actions to a second user located with the machine.

12. The method of claim 10, further comprising:
providing data representing the operation of the injection molding machine to an expert remote from the machine;
receiving a diagnosis of the machine from the remote expert; and
providing the remote expert diagnosis to a second user located with the machine.

13. The method of claim 10, further comprising:
automatically generating overall equipment effectiveness analysis based on the received operational data; and
provide the overall equipment effectiveness analysis to the remote user.

14. The method of claim 10, further comprising:
generating one or more predictions representing the future operation of the machine based on a applying a statistical analysis of operation data from a plurality injection molding machines to the operation data received from the injection molding machine.

15. The method of claim 14, further comprising:
deploying a sensor on the injection molding machine; and
receiving data from the sensor;
wherein the one or more predictions are further generated based on the sensor data.

16. The method of claim 10, wherein the controller is configured to accumulate and store operational data for the injection molding machine for later remote retrieval.

17. The method of claim 10, further comprising:
deploying a firewall between the controller and the remote data center configured to prohibit control of the injection machine through the network.

18. At least one non-transitory processor readable storage medium storing a computer program of instructions configured to be readable by at least one processor for instructing the at least one processor to:
store a measurement taken of an injection molding machine to a machine controller associated with that machine;
receive operation data for the injection molding machine including the stored measurement from the machine controller; and
remotely display the received data including the stored measurement to a first user at a location distant from the machine.

19. The medium of claim 18, wherein the at least one processor is further instructed to:
remotely determine a status of the machine based on the received data;
determine one or more remedial actions in response to the status of the machine; and
communicate the one or more remedial actions to a second user located with the machine.
